(19) United States
(12) Patent Application Publication
(10) Pub. No.: US 2006/0103307 A1
(43) Pub. Date: May 18, 2006

(54) Field enhanced plasma display panel

(75) Inventors: Qun Yan, Wallkill, NY (US); Padmanabha Rao Ravilisetty, Highland, NY (US); Benjamin L. Ballard, Highland, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Matsushita Electric Industrial Co., Ltd.

(21) Appl. No.: 10/990,565

(22) Filed: Nov. 17, 2004

(51) Int. Cl. H01J 17/49

(52) U.S. Cl. 313/582

(57) ABSTRACT

A gas discharge device is provided, which includes a plurality of electrodes; and a field enhanced material disposed on the electrodes; wherein the plurality of electrodes and the field enhanced material are enclosed a vessel containing a dischargeable gas such that at least the field enhanced material is exposed to the dischargeable gas. Also provided is a plasma display panel, which includes a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes being in spaced adjacency therewith; and a phosphor layer disposed on top of the dielectric layer between the barrier ribs; wherein each of the phosphor layers includes a field enhanced material that is disposed on the surface of each phosphor layer or is imbedded therein.

### BACKGROUND OF THE INVENTION

1. Field of the Invention

The present invention relates to electric field enhancement materials and electron emitting materials in a color plasma display panel (Color PDP) used as a flat panel display. More particularly, the present invention provides nanotube, nanowire, nanobelt, nanocone, microtube, and microfiber, and nanocage materials and composite nanostructures, which are used to enhance the electric field for reducing the driving voltage of the discharge and increase emitting electrons as a priming source for faster addressing.

2. Description of the Related Art

Most commercial plasma display panels (PDP's) are of the surface discharge type. The constitution of a plasma display panel of the prior art is described below with reference to the accompanying drawing.

FIG. 1 shows a schematic constitution of the color plasma display panel. An AC color PDP includes a front plate (front glass substrate) 110 with sustain electrodes 111 and 112 for each row of pixel sites. The front plate 110 with electrodes 111 and 112 is also covered by a dielectric glass layer 113 and a protective layer 114 made of magnesium oxide (MgO).

The conventional PDP also includes a back plate 115 upon which plural column address electrode 116 (also called data electrode) are covered by a dielectric layer 117 and separated by barrier 118. Red phosphor layer 120, green phosphor layer 121, and blue phosphor layer 122 are put on top of the dielectric layer 117.

In a surface discharge type PDP, an inert gas mixture, such as Ne—Xe, fills a space 225 between front plate assembly 210-214 and back plate assembly 215-221 as shown in FIG. 2.

Referring to FIG. 2, barrier ribs 218 separate the color channel and construct sub-pixels 200 with sustain electrodes 211. A gas discharge generated by a sustain voltage between sustain electrodes creates vacuum ultraviolet (VUV) light that excites the red, green, and blue phosphor layers, respectively to emit visible light. For example, the green phosphor 221 in the sub-pixel 200, as shown in FIG. 2, is excited by the VUV light to generate the green light from green phosphor layer.

FIG. 3 shows a sub pixel which is defined as an area that includes intersections of an electrode pair of a transparent sustain electrode 311 (and its adjacent bus electrode 310) and scan electrode 312 (and its adjacent bus electrode-313) on the front plate, and a data electrode 316 on the back plate.

The operating sustain voltage of a PDP is determined by a sustain gap 330 geometry, dielectric layer, gas mixture, and the secondary electron emission coefficient of the protective MgO layer 314 on the front plate. The visible light generated in the sustain discharges is responsible for the brightness of a color PDP. The initiation of sustain discharges is achieved by an addressing discharge through the plate gap 331 prior to sustain discharges, which will be described later. A full color image is generated by appropriately controlling the driving voltage on sustain electrodes and addressing electrodes.

In order to exhibit a full color image on a plasma display panel (PDP) from a video source, a proper driving scheme is needed for sufficient gray scale and minimum motion picture distortion. In AC plasma display panels, a widely used driving scheme to accomplish gray scale in pixels is the so called ADS (address display separated) suggested by Shinoda (Yoshikawa K, Kanazawa Y, Wakitani W, Shinoda T and Ohtsuka A, 1992 Japan. Display 92, 605).

Referring to FIG. 4, it can be seen that in this method, a frame time of 16.7 milliseconds (one TV field) is divided into eight sub-fields as shown in FIG. 4. Each of the eight sub-fields is further divided into an address period and a sustain period. Pixels previously addressed are turned on and emit light during the sustain period. The duration of the sustain period depends on the sub-field. By controlling the addressing of a given pixel during the addressing period, the intensity of the pixel can be varied to any of the 256 gray scale levels.

As shown in the FIG. 4, the time used in addressing consumes a large fraction of the frame time (16.7 ms) because each line of the display has to be addressed in every sub-field. To minimize the motion picture distortion (MPD) due to the time-modulation brightness scheme like ADS, more sub-fields, such as 10 to 12 sub-fields, are required to overcome this problem. A plasma display panel used as an HDTV (high definition TV, 720 p, or 1080 i) set or even a FHD (full high-definition TV, 1080 p) set requires more lines to display better images. Scan pulse timing in each sub-field is the sum of the addressing time of every horizontal line (scan electrodes). The total scanning time in a TV display field (16.7 ms) is the multiple of the number of sub-fields and the scanning pulse timing in each sub-field. More sub-fields and higher resolutions PDP TV set requires a shorter total scanning time to leave enough time for the sustain periods which determine the brightness of the display. This requirement translates to faster addressing in each sub-pixel. To achieve a fast and reliable addressing, the delay time of the start of the plate gap discharge should be kept as short as possible and the jitterof the discharge should also be kept as low as possible.

The delay time of the start of the discharge, also called the formative delay, is determined by the electric field across the gas in the plate gap. The stronger the field across the gas the shorter the formative delay of the discharge. The jitter of the discharge, also defined as statisitical delay, is mainly due to the quanity of priming particles (UV photons, electrons, ions, and metastable atoms) present at address time. More priming particles left at the address time lowers the jitter occurring during addressing (shorter statistical delay).

To reduce the cost of data driving circuits, the address voltage applied on the data electrodes is kept below about 80V. The object of this invention is to provide a stronger field in the plate gap without increasing the address voltage. It may be possible to even reduce this voltage. Another object is to provide a better priming condition at the time of addressing. As a result, the goal of fast addressing can be accomplished.

### SUMMARY OF THE INVENTION

The object of the present invention is to improve color plasma display panels (PDP) performance by significantly reducing address time and/or address voltage. An extremely fast address time (<1 us) can provide more time for more sub-fields which results in higher resolution and/or more time for sustains which increase brightness.

To achieve the above object, field-enhancing material, such as, nanotube, nanowire, nanobelt, nanotree, nanocone, nanofibres, microtube, microwire, microcone, microfibers, nanocage or a combination thereof, is added in the back plate structure to reduce the breakdown voltage of the plate gap (the gap between front plate and back plate) and to increase priming particles resulting in a much faster addressing.

Accordingly, the present invention provides a gas discharge device including a plurality of electrodes and a field enhanced material disposed on the electrodes, wherein the plurality of electrodes and the field enhanced material are enclosed in a vessel containing a dischargeable gas such that the field enhanced material is exposed to the dischargeable gas.

The present invention also provides a phosphor layer/film, such as, a red, green or blue phosphor layer, disposed on a substrate, including a field enhanced material disposed on the surface of the phosphor layer/film or imbedded therein.

The present invention further provides a plasma display panel, which satisfies the above objectives. The plasma display includes: a first substrate having a plurality of barrier ribs; a second substrate disposed on the first substrate such that the barrier ribs form a vessel between the first substrate and the second substrate for containing a dischargeable gas; a field enhanced material disposed in the vessel; and a plurality of electrodes on the first and the second substrates separated by a plurality of barrier ribs, wherein the vessel contains a dischargeable gas such that the field enhancing material is exposed to the dischargeable gas.

In one aspect, the plasma display panel according to the present invention includes a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes being in spaced adjacency therewith; and a phosphor layer disposed on top of the dielectric layer between the barrier ribs; wherein each of the phosphor layers includes a field enhanced material that is disposed on the surface of each phosphor layer or is imbedded therein.

In another aspect, the plasma display panel according to the present invention includes, the plasma display panel according to the present invention includes a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes being in spaced adjacency therewith; and a red phosphor layer, a green phosphor layer and blue phosphor layer sequentially disposed on top of the dielectric layer between the barrier ribs; wherein each of the red, green and blue phosphor layers includes a field enhanced material that is disposed on the surface of each phosphor layer or is imbedded therein.

Preferably, the field enhanced material is a nano material, such as, a carbon nanotube or nanocages. The carbon nanotube/cage (CNT) used in the back plate provides a strong field enhancement inside the plate gap and good electron emission. Field enhancement by carbon nanotube (CNT) helps to reduce the breakdown voltage of plate gap, which results in a significant reduction of address time or a reduction of the address voltage.

The electron emission from carbon nanotube (CNT) also improves the priming condition for the addressing discharge. As a result, a faster addressing is achievable.

These and other advantages will become apparent from the detailed description of the invention with reference to the drawings.

### BRIEF DESCRIPTION OF THE DRAWINGS

FIG. 1 is a schematic diagram of a conventional color plasma display structure (prior art).

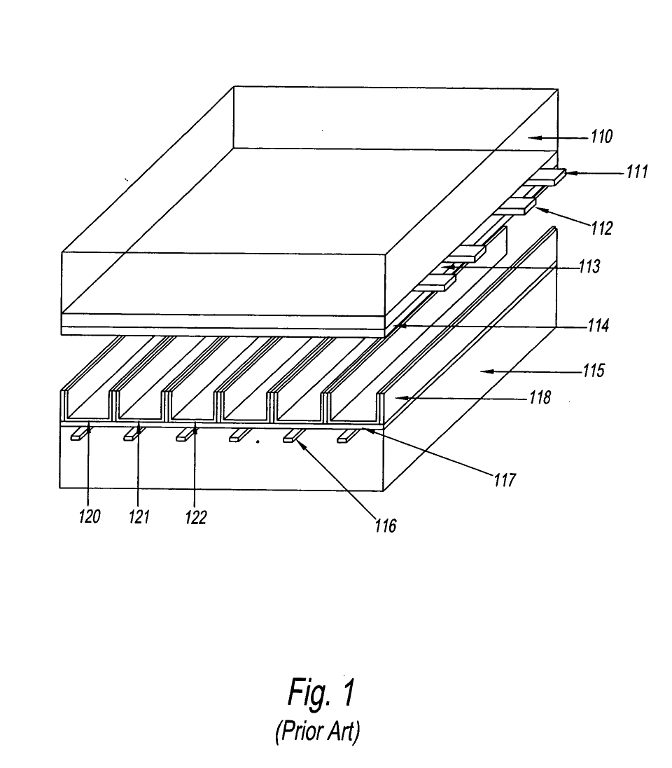

FIG. 2 is a diagram of an AC color plasma display single sub pixel structure (prior art).

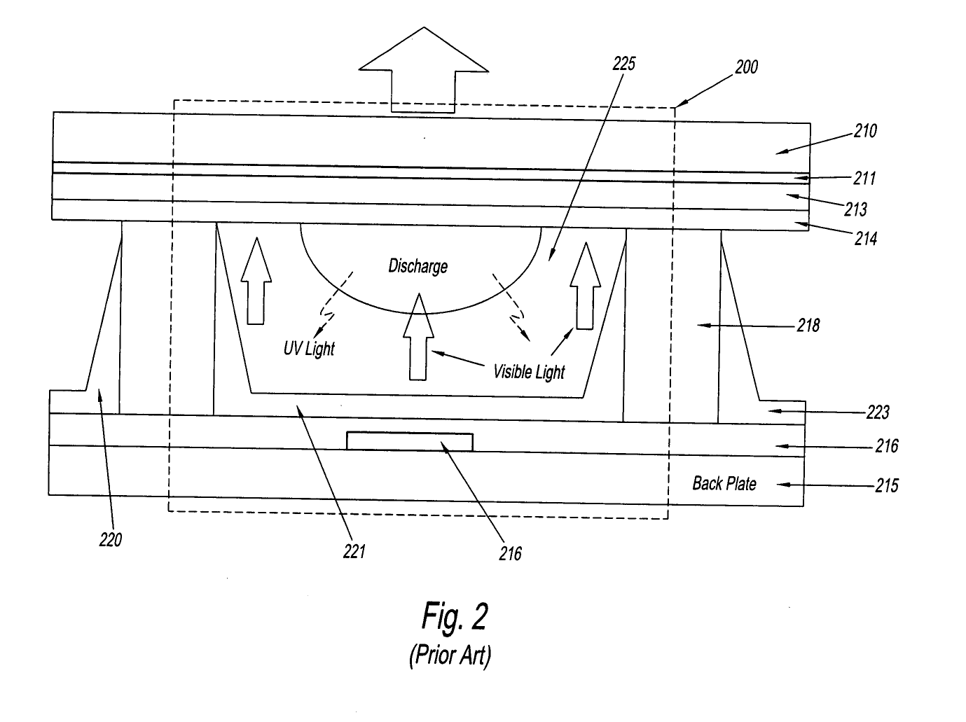

FIG. 3 shows a diagram of the electrodes, sustain gap, plate gap in a sub-pixel (prior art).

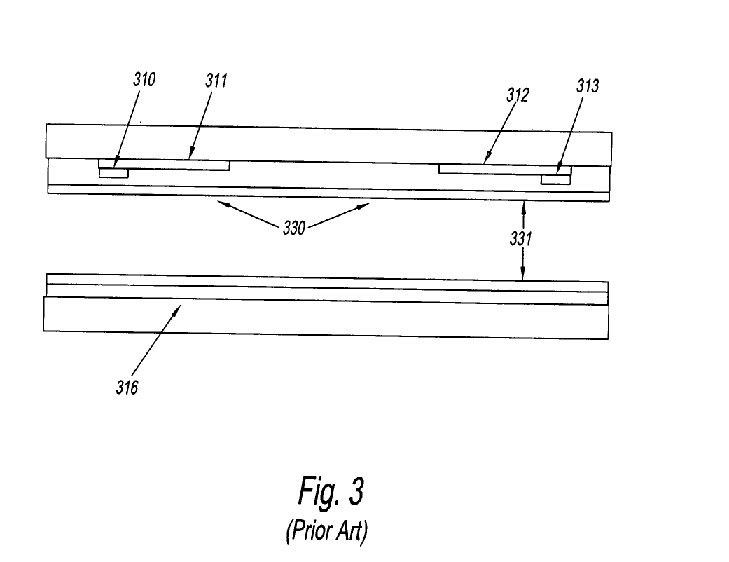

FIG. 4 is a driving scheme of address display separation (ADS) gray scale technique (prior art).

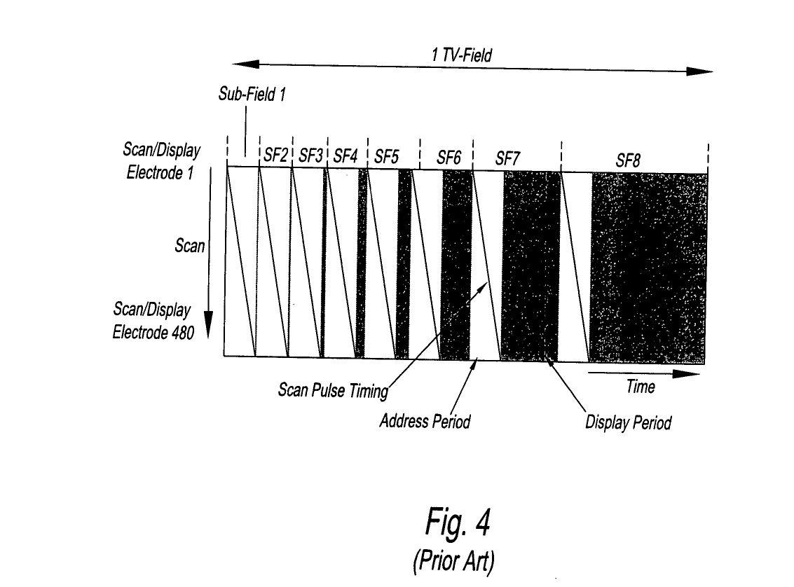

FIG. 5 is a diagram of a section of normal phosphor layer (prior art).

FIG. 6 is a diagram of a field enhancement material carbon nanotube (CNT) on top of and commingled with the top of the phosphor layer.

FIG. 7 is a diagram of a phosphor mixed with a randomly arranged field enhancement material carbon nanotube (CNT).

FIG. 8 is a diagram of arrayed nanotube or nanowire material imbedded in the phosphor layer/film.

FIG. 9 is a comparison among the formative delay of the address discharge for a conventional structure with phosphor layer only, a structure with carbon nanotube covered by phosphor layer, and structures with carbon nanotube materials imbedded in phosphor layer but still exposed to discharge gas.

FIG. 10 is a comparison among the statistical delay of the address discharge for a conventional structure with phosphor layer only, a structure with carbon nanotube covered by phosphor layer, and structures with carbon nanotube materials imbedded in phosphor layer but still exposed to discharge gas.

FIG. 11 is a diagram of the back plate structure with a carbon nanotube layer under a phosphor layer (prior art).

FIG. 12 is a diagram of the field enhanced material is put in the area above the data electrode and below the scan bus electrode.

FIG. 13 illustrates a general embodiment of color plasma display panel with the present invention.

### DESCRIPTION OF THE PREFERRED EMBODIMENTS

The present invention includes field enhanced material in a gas discharge device. The field enhanced material is disposed on top of an electrode and is directly exposed to dischargeable gas. The electrode can also be covered by a dielectric and the field enhanced material disposed on the surface of dielectric material.

The field enhanced material in the gas discharge device according to the present invention can be Carbon, Silicon, Silicon Oxide, Germanium, Germanium Oxide, Magnesium Oxide, Aluminum Oxide, Zinc, Zinc Oxide, Indium Tin Oxides, Tin Oxides, (TCOs) or a combination thereof.

Preferably, the field enhanced material is in a form, such as, a nanotube, nanowire, nanobelt, nanotree, nanocone, nanofibres, microtube, microwire, microcone, microfibers nanocage and a combination or composite thereof, whose diameters are in the range of 1-100 nm, or microtube, microwire, microcone, and microfibers whose diameters are in the size range of 0.1 μm to 100 μm, or a combination thereof. Preferably, the nano material is Carbon nanotube or carbon nanocages.

The term “inter-disposed” in the context of the present invention has the meaning of being disposed near the surface of a material, being partially or wholly imbedded therein. Preferably, the field enhanced material is inter-disposed on at least a portion of a surface of the phosphor material. However, it can be inter-disposed on the entire surface of the phosphor layer or disposed within the entire body of the phosphor layer.

Preferably, the dischargeable gas includes at least one element, such as, Xenon, Neon, Argon, Helium, Krypton, Mercury, Nitrogen, Oxygen, Fluorine and Sodium.

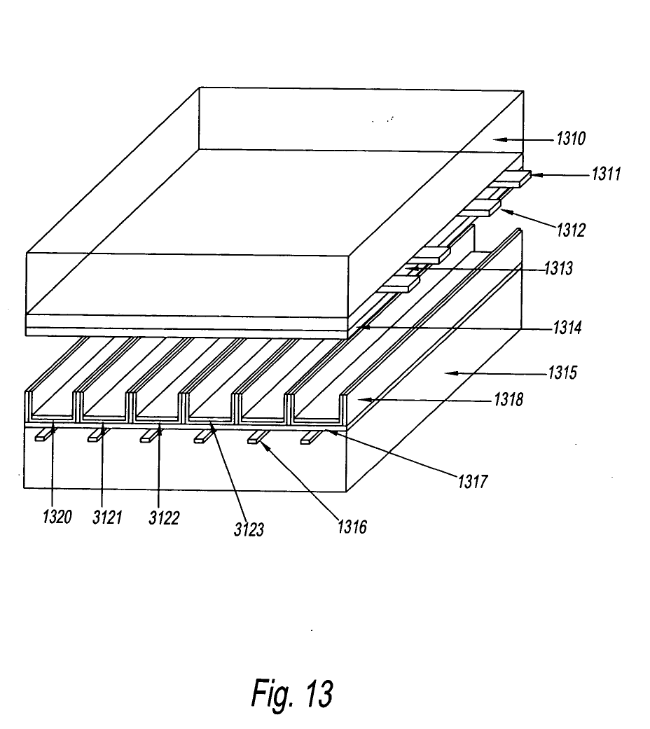

FIG. 13 illustrates a general embodiment of color plasma display panel with the present invention. The color plasma display panel (PDP) includes a front plate (front glass substrate) 1310 with a scan electrode 1311 and a sustain electrodes 1312 for each row of pixel sites. The front plate 1310 with electrodes 1311 and 1312 is also covered by a dielectric glass layer 1313 and a protective layer 1314 made of magnesium oxide (MgO). The plasma display panel (PDP) also includes a back plate 1315 upon which plural column address electrode 1316 (also called data electrode) are covered by a dielectric layer 1317 and separated by barrier rib 1318. Red phosphor layer 1320, green phosphor layer 1321, and blue phosphor layer 1322 are disposed on top of the dielectric layer 1317. The plasma display panel (PDP) according to present invention includes a field enhanced material 1323 on the surface of phosphor layers or imbedded in phosphor layer 1320, 1321, and 1322.

Normal back plate structure includes of an address electrode, dielectric glass layer, barrier ribs, and phosphor layer on the back plate glass substrate. The phosphor layer includes three different phosphor emitting red, green, and blue colors. The phosphor layer of normal plasma display panels are (Y,Gd)BO₃:Eu³⁺ for red, a blend of (Y,G)BO₃:Tb³⁺ and Zn₂SiO₄:Mn²⁺ for green, and BaMgAl₁₀O₁₇:Eu²⁺ for blue.

The field enhanced material in the plasma display panel according to the present invention can be Carbon, Silicon, Silicon Oxide, Germanium, Germanium Oxide, Magnesium Oxide, Aluminum Oxide, Zinc, Zinc Oxide, Tin Oxide, Indium Tin Oxide, (TCOs) or a combination thereof.

Preferably, the field enhanced material is in a form, such as, a nanotube, nanowire, nanobelt, nanotree, nanocone, nanofibres, nanocages , or a combination thereof, whose diameters are in the range of 1-100 nm, or microtube, microwire, microcone, and microfibers whose diameters are in the size range of 0.1 μm to 100 μm, or a combination thereof. Preferably, the nano material is Carbon nanotube nanocages.

The field enhanced material can be applied either onto a portion of each of the red, green and blue phosphor layers or onto the entire layer or it can be imbedded in either a portion of each of the red, green and blue phosphor layers or into the entire red, green and blue phosphor layer.

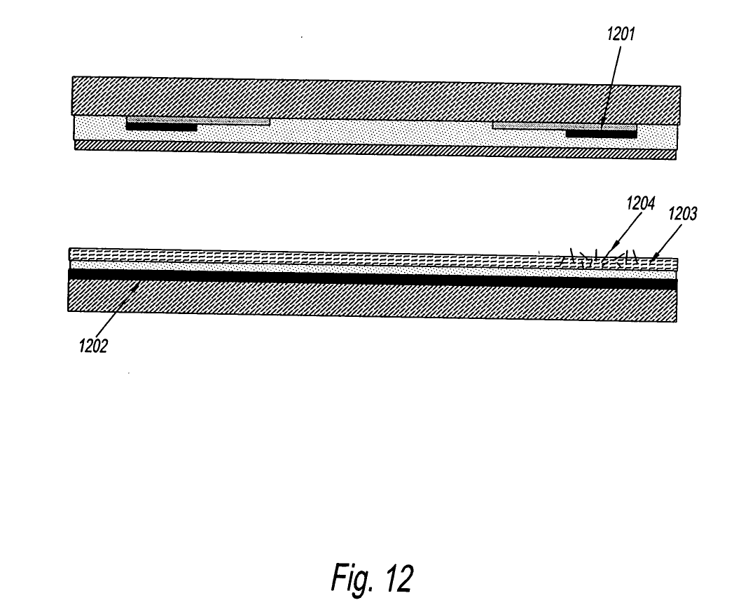

FIG. 12 shows one example of the field enhanced material 1204 is applied onto a portion of phosphor layer 1203. In this particular case, the field enhanced material 1204 is put in selected area above data electrode 1202 and under scan bus electrode 1201 area. The field enhanced material imbedded or coated on a portion of phosphor layer is not limited to this example.

The field enhanced material can be an aligned array of field enhanced nano material. Preferably, at least a portion of the field enhanced nano material is an aligned array of field enhanced nano material.

The plasma display panel according to the present invention can further include a binding material for binding the field enhanced material, which can be a phosphor material.

In one embodiment, the field enhanced material is present in the non-phosphor regions. The non-phosphor regions is the regions that is not covered by phosphor layer in the back plate, such as in the region between pixels.

The plasma display panel according to the present invention can further include field enhancement tips imbedded in the red, green and blue phosphor layers or in the non-phosphor regions of the back plate assembly. Any back plate structure with field enhancement material or structure is also covered by the present invention.

The field enhanced material can be formed, for example, on the barrier ribs of the back plate, by a method, such as:

(a) electrophoretic deposition;

(b) screen printing of field enhanced material;

(c) printing by an ink-jet process; or

(d) aerosol coating of the field enhanced material on the barrier ribs of the back plate.

Phosphors used in normal plasma display panels are usually fired at very high temperature (for example, around 1200° C. depending on the composition of the phosphor) at which crystals are likely to grow into spheroidal shapes and in the size of 2 to 10 μm. Phosphor layers are formed either by ink jet printing or by screen printing of a mixture that contains phosphor particles and a vehicle (organic paste). The panel is then fired at a temperature around 450° C.-550° C. for removing an organic binder component in the paste.

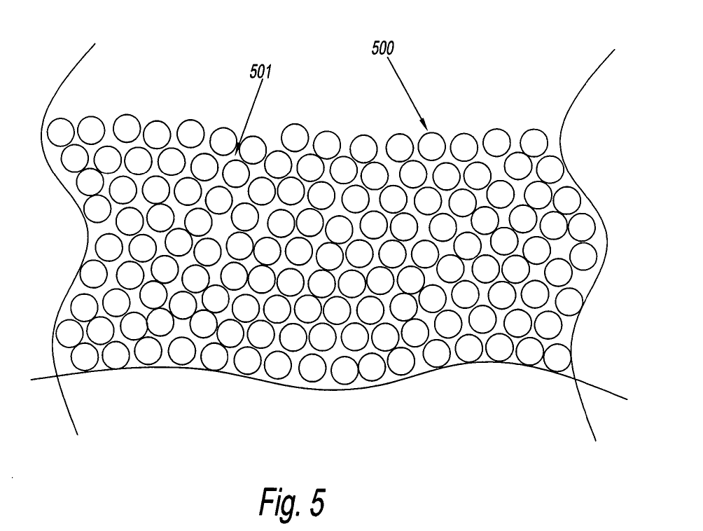

Referring to FIG. 5, it can be seen that the phosphor layers typically have some voids 501 between phosphor particles 500 after the binder burning off process as shown in FIG. 5.

Normal plasma display panel materials in the back plates (including phosphor layers) usually do not provide good priming particles during the addressing discharge. This invention intends to put field enhancement and electron emitting materials in the back plate to either reduce the breakdown voltage in the plate gap or promote electron emission for priming particles.

The breakdown voltage of the plate gap is determined by the gas mixture, electric field across the gap, and the secondary electron emission coefficient of the MgO film on the front plate and the phosphor layers in the back plate. Nanotube, nanowire or nanocone nanocage materials have needle-like structures that can create strong electric field enhancement when the voltage is applied (Bonard, J. M., Kind, H., Stockli, T., and Nilsson, L. A., Solid-State Electronics, 45, (6), 893-914, 2001).

Accordingly, the present invention also provides a phosphor layer, such as, a red, green or blue phosphor layer, disposed on a substrate, including a field enhanced material disposed on the surface of the phosphor layer or imbedded therein. The field enhanced material can be applied onto at least a portion (or all) of the surface of each of the phosphor layers or it can be imbedded in at least a portion (or the entire body) of each of the phosphor layers.

Such phosphor layers, i.e., red, green or blue phosphor layers, have utility in fluorescent lamp, discharge lamp, plasma display panels, field emission panels, and other emissive display which use phosphor layers.

Although nanotube materials, such as, carbon nanotubes have been applied in field emission displays (FED) as electron emission tip, those field-enhancing materials have not been successfully used in the plasma display panel application until this invention.

In the present invention, nano tube, nano wire or nano cone materials are embedded on the surface or at least close to the top surface of the phosphor layers above the data electrode area creating strong field enhancement across the gas in the plate gap. Therefore lower addressing voltage is expected. If the field enhancing material happens to be a good electron emitter, the increased electron emission provides a better priming. This can reduce the statistical delay (jitter) of the addressing discharge, and the further reduction of addressing time can be achieved.

To achieve the above goal, the field-enhancing material has to be in close contact with the gas mixture above the electrode area inside the plasma display panel. Carbon nanotube (CNT) is well known for its field-enhanced properties and as being anelectron emitter.

We have developed several techniques for putting nano materials such as carbon nanotube (CNT) into back-plate structures. Some of these techniques are described in the following non-limiting examples:

### EXAMPLE 1

The first approach is to deposit carbon nanotube (CNT) on top of the phosphor layer or portion of the phosphor layer by an electrophoretic deposition process. The carbon nanotube (CNT) material is put into an alcohol solution and an electric static field is applied between a metal electrode and electrodes 616 in the back plate.

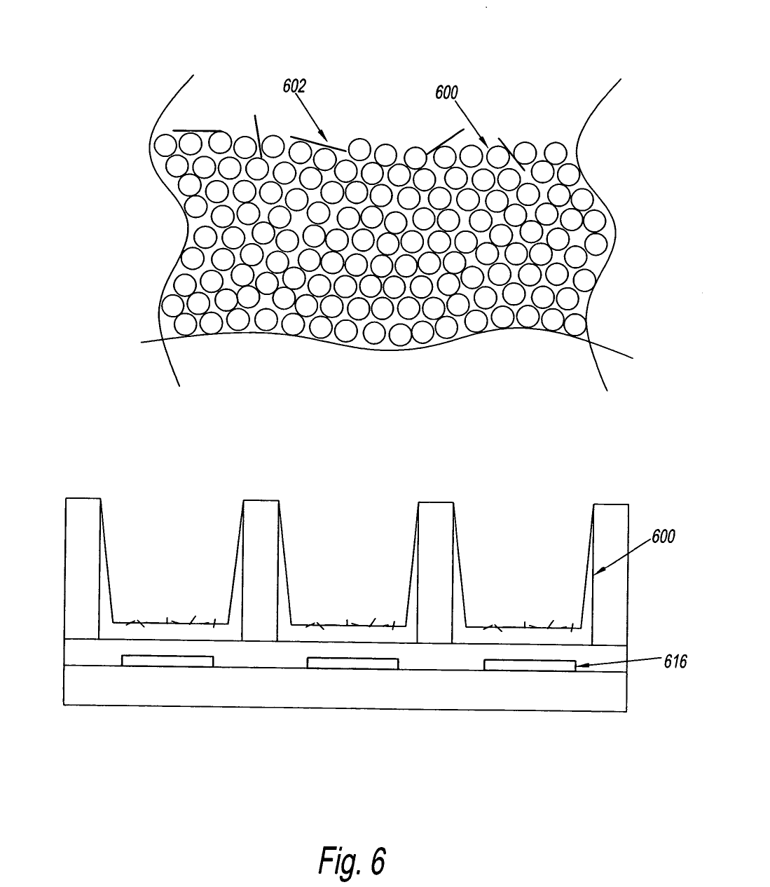

Referring to FIG. 6, it can be seen that CNT 602 can be uniformly coated on the phosphor area right above the data electrodes 616 as shown in FIG. 6. With proper masking and patterning technique, one can also coat selected area of the phosphor layer above the data electrodes. Thus, the first embodiment of incorporating field enhanced material is to deposit carbon nanotube (CNT) on top of the phosphor layer or portion of the phosphor layer by an electrophoretic deposition process. The carbon nanotube (CNT) material is first put into an alcohol solution in the range of 0.01 mg/L to 100 mg/L for dilution. An electric static field is applied in the solution between a metal electrode and data electrodes 616 in the back plate. As a result, CNT 602 can be uniformly coated on the phosphor area right above the data electrodes 616 as shown in FIG. 6. With proper masking and patterning technique, one can also coat selected area of the phosphor layer above the data electrodes. Si nanowire, SiO2 nanowire, ZnO nanowire, and other nanowire, nanotube, and nanocone material can also be deposited by this method.

### EXAMPLE 2

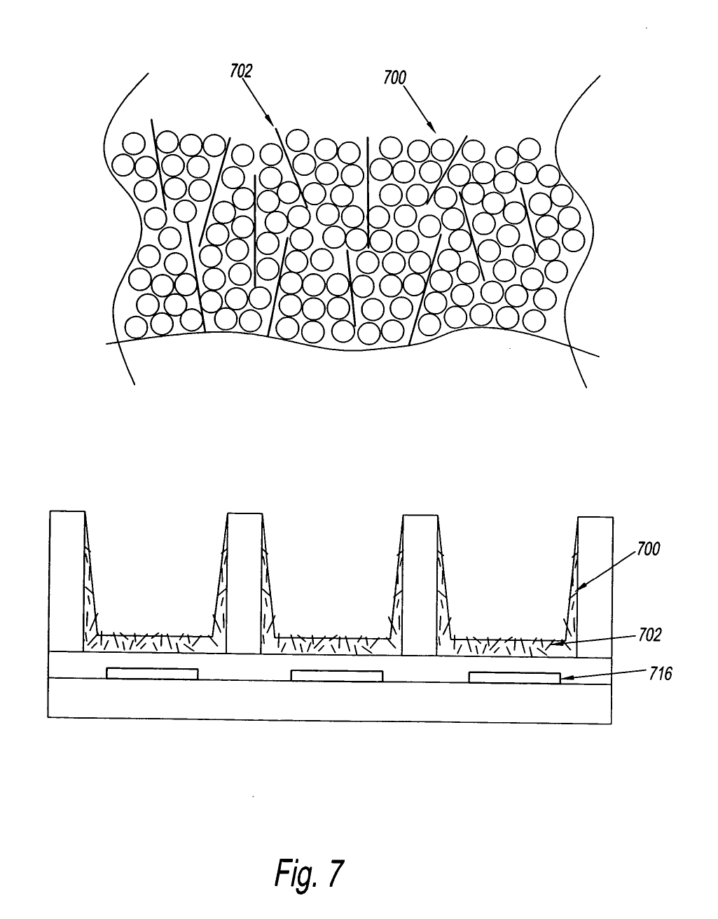

The second approach of incorporating field enhanced material is to mix carbon nanotube material with phosphor particles. The carbon nanotube (CNT) is mixed with phosphor in the range of 0.01% to 90% by weight. The mixture of carbon nanotube (CNT) with is coated onto the rib structure by either screen printing or ink-jet process, and then it is fired to remove the organic binder. The final phosphor layers have carbon nanotube materials 702 randomly filled in those voids between the phosphor particles 700 as shown in FIG. 7. With proper masking and patterning technique, one can also coat the mixture in partial area of phosphor layer. Other nanotube, nanowire, and nanocone materials can also be imbedded in phosphor layers by this technique.

Referring to FIG. 7, it can be seen that the final phosphor layers have carbon nanotube materials 702 randomly filled in those voids between phosphor particles 700 as shown in FIG. 7.

### EXAMPLE 3

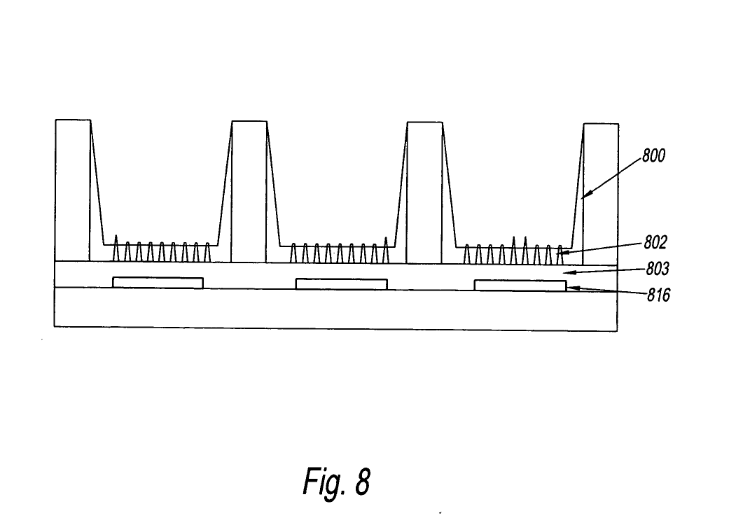

Referring to FIG. 8, it can be seen that in the third approach, phosphor particles 800 are put in the open space of a vertical aligned carbon nanotube array 802 as shown in FIG. 8. The third embodiment of imbedding field enhanced material is to put phosphor particles 800 in the open space of a vertical aligned carbon nanotube array 802 as shown in FIG. 8. First, vertically aligned carbon nanotubes (CNT) are grown on the top of dielectric layer 803 at selected areas above data electrodes 816. The aligned carbon nanotubes (CNT) are grown by a low temperature CVD process (below 500° C.). Later, the phosphor layers can be deposited by a screen printing or in-jet printing process, and then it is fired to remove the organic binder.

The present invention is not limited by those approaches mentioned above. Any combination of putting field enhanced materials in close contact with the gas or any structure involving field enhanced materials for promoting electron emission and/or enhancing the field between the plate gap is the core of this invention.

The present invention is further described in detail in the context of a plasma display panel with reference to the accompanying drawings.

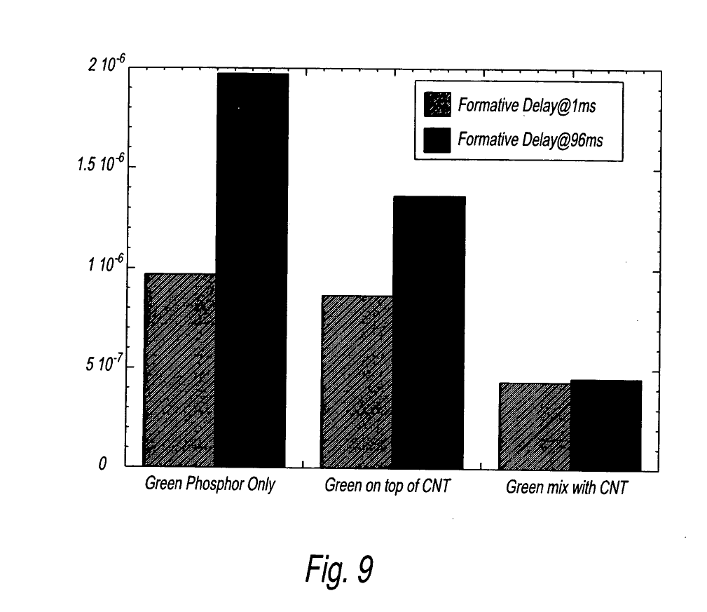

FIG. 9 shows the comparison of the formative delay of an addressing discharge among a panel with normal green phosphor in the back plate, a panel with CNT covered by green phosphor, and a panel with CNT mixed with green phosphor. The formative delay of below 600 ns is achieved in the panel with mixture of CNT and green phosphor when the panel is addressed at 96 ms (almost 6 TV field) delay after a reset pulse.

The addressing time is determined by the formative delay and statistical delay. The shorter of the formative and statistical delay, the faster of addressing the PDP. The benefit of faster addressing has been discussed in the background section of the present invention.

Compared to a conventional panel with a formative delay of about 2000 ns, the improvement is more than a factor of three in reduction of the formative delay time.

The formative delay in the address discharge depends upon the plate gap discharge which then spreads to the sustain gap discharge. Carbon nanotube imbedded in or on the top of the phosphor layer help to enhance the electric field and lower the breakdown voltage of the plate gap discharge. As a result, at the same address voltage, breakdown of the plate gap is much faster in these configurations.

The significant reduction of the formative delay is directly predicted by the idea of the field enhancement introduced by the carbon nanotube.

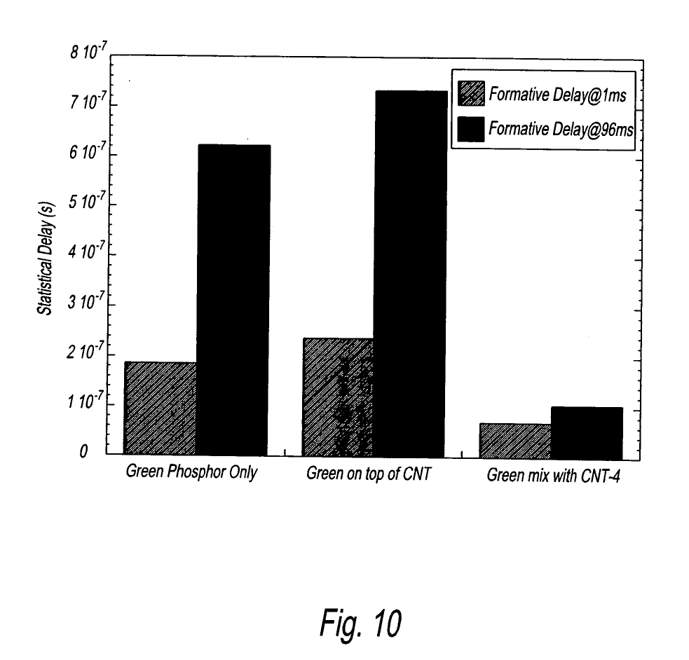

Referring to FIG. 10, it can be seen that the reduction of statistical delay is even more significant. The statistical delay at 96 ms after a reset pulse for the panel with mixture of CNT and phosphor is below 100 ns, more than six times reduction compared to 600 ns in the conventional case.

The statistical delay is related to the priming condition at the addressing time. Carbon nanotube is a good electron emitter material. Electron emission from carbon nanotubes (CNT) helps the priming situation at the addressing time. The significant improvement of the statistical delay indicates that better priming conditions exist when carbon nanotubes are added into or on top of the phosphor layers.

An attempt at putting carbon nanotube (CNT) between phosphor layer and a data electrode (or a dielectric layer) has been described by Won-tae Lee, et al. (U.S. Pat. No. 6,346,775). We also have tried that approach and the results are presented herein below.

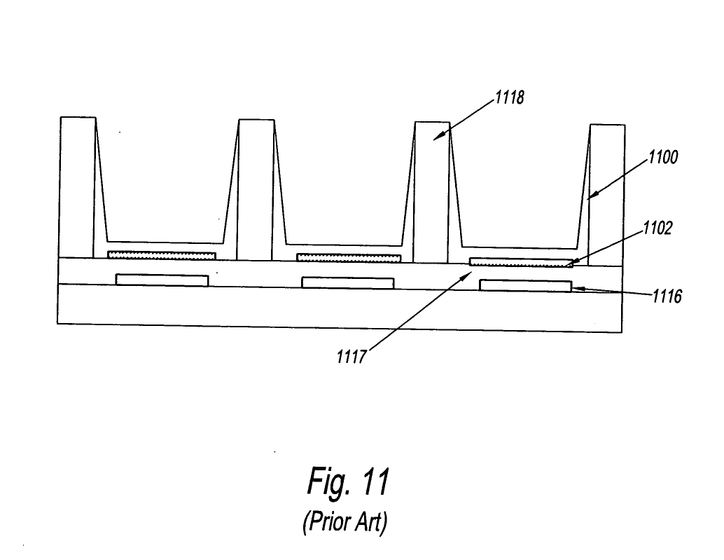

FIG. 11 shows the structure described by the patent. Layers of carbon nanotube 1102 are put between phosphor layers 1100 and dielectric glass layer 1117 and separated by the barrier rib 1118. Since the carbon nanotube (CNT) layers are covered by the phosphor layer, the field enhancement or electron emission properties of carbon nanotube (CNT) is almost non existent.

Referring to FIG. 9, it can be seen that the formative delay of the address discharge from this structure shows very close to the conventional case at a 1 ms delay after the reset pulse. For a 96 ms delay, there is only a 25% improvement compared to a 75% improvement when the carbon nanotube (CNT) is exposed to the gas as in this invention. Actually, there is no improvement in statistical delay and even longer delays are shown than in the conventional case. This result is no surprise because the carbon nanotube layer is covered by the phosphor layer, and electrons can not penetrate the phosphor layer which is typically 15 to 20 micrometers thick. The address timing is the sum of the formative delay and the statistical delay. Over all there is almost no improvement in term of addressing time from the previously patented structure.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A gas discharge device comprising:
a plurality of electrodes; and
a field enhanced material disposed on said electrodes;
wherein said plurality of electrodes and said field enhanced material are enclosed a vessel containing a dischargeable gas such that at least said field enhanced material is exposed to said dischargeable gas.

2. The gas discharge device of claim 1, further comprising:
a dielectric material between said electrodes and said field enhanced material.

3. The gas discharge device of claim 1, wherein said electrodes are also exposed to said dischargeable gas.

4. The gas discharge device of claim 1, wherein said field enhanced material is disposed on a surface of said electrodes.

5. The gas discharge device of claim 1, further comprising a phosphor material.

6. The gas discharge device of claim 5, wherein said field enhanced material is inter-disposed on a surface of said phosphor material.

7. The gas discharge device of claim 6, wherein said field enhanced material is inter-disposed on at least a portion of said surface of said phosphor material.

8. The gas discharge device of claim 6, wherein said field enhanced material is disposed within the entire body of said phosphor material.

9. The gas discharge device of claim 1, wherein said field enhanced material is selected from the group consisting of: Carbon, Silicon, Silicon Oxide, Germanium, Germanium Oxide, Magnesium Oxide, Aluminum Oxide, Zinc, Zinc Oxide Tin Oxide, Indium Tin Oxide and a combination thereof.

10. The gas discharge device of claim 1, wherein said field enhanced material is a nano material.

11. The gas discharge device of claim 10, wherein said nano material is in the form of a nanotube, nanowire, nanobelt, nanotree, nanocone, nanofibres, nanocage, microtube, microwire, microcone, microfibers and a combination thereof.

12. The gas discharge device of claim 10, wherein said nano material is Carbon.

13. The gas discharge device of claim 6, wherein said field enhanced material is applied onto the entire surface of said phosphor layer.

14. The gas discharge device of claim 6, wherein said field enhanced material is imbedded in the entire body of said phosphor layer.

15. The gas discharge device of claim 1, wherein at least a portion of said field enhanced material is an aligned array of field enhanced nano material.

16. The gas discharge device of claim 1, wherein said field enhanced material is an aligned array of field enhanced nano material.

17. The gas discharge device of claim 1, wherein said phosphor layer comprises a phosphor material selected from the group consisting of: a red phosphor, a green phosphor, a blue phosphor and a combination thereof.

18. The gas discharge device of claim 1, wherein said vessel comprises a substrate.

19. The gas discharge device of claim 18, wherein said substrate comprises a plurality of barrier ribs perpendicular thereto.

20. The gas discharge device of claim 19, wherein said field enhanced material is disposed on at least a portion of said substrate.

21. The gas discharge device of claim 20, wherein said field enhanced material is disposed on at least a first portion of said barrier ribs.

22. The gas discharge device of claim 20, wherein said field enhanced material is inter-disposed with said phosphor on at least a second portion of said barrier ribs.

23. The gas discharge device of claim 1, wherein said dischargeable gas comprises at least one element selected from the group consisting of: Xenon, Neon, Argon, Helium, Krypton, Mercury, Nitrogen, Oxygen, Fluorine and Sodium.

24. The gas discharge device of claim 1, wherein said gas discharge device is a fluorescent lamp.

25. The gas discharge device of claim 1, wherein said gas discharge device is a high intensity discharge lamp.

26. The gas discharge device of claim 1, wherein said gas discharge device is a plasma display.

27. A phosphor layer disposed on a substrate, comprising a field enhanced material disposed on the surface of said phosphor layer or imbedded therein.

28. The phosphor layer according to claim 27, wherein said field enhanced material is applied onto at least a portion of said phosphor layer.

29. The phosphor layer according to claim 27, wherein said field enhanced material is imbedded in at least a portion said phosphor layer.

30. The phosphor layer according to claim 27, wherein said field enhanced material is selected from the group consisting of: Carbon, Silicon, Silicon Oxide, Germanium, Germanium Oxide, Magnesium Oxide, Aluminum Oxide, Zinc, Zinc Oxide and a combination thereof.

31. The phosphor layer according to claim 27, wherein said field enhanced material is a nano material.

32. The phosphor layer according to claim 31, wherein said nano material is in the form of a nanotube, nanowire, nanobelt, nanotree, nanocone, microtube, microwire, microfibers nanocage and a combination thereof.

33. The phosphor layer according to claim 31, wherein said nano material is Carbon.

34. The phosphor layer according to claim 27, wherein said field enhanced material is applied onto the entire surface said phosphor layer.

35. The phosphor layer according to claim 27, wherein said field enhanced material is imbedded in the entire body of said phosphor layer.

36. The phosphor layer according to claim 27, wherein at least a portion of said field enhanced material is an aligned array of field enhanced nano material.

37. The phosphor layer according to claim 36, wherein said field enhanced material is an aligned array of field enhanced nano material.

38. The phosphor layer according to claim 27, wherein said phosphor is selected from the group consisting of: a red phosphor, a green phosphor, a blue phosphor and a combination thereof.

39. The phosphor layer according to claim 27, further comprising:
a dielectric layer disposed between said substrate and said phosphor layer.

40. A plasma display, comprising:
a first substrate having a plurality of barrier ribs;
a second substrate disposed on said first substrate such that said barrier ribs form a vessel between said first substrate and said second substrate for containing a dischargeable gas;
a field enhanced material disposed in said vessel; and
a plurality of electrodes on said first and said second substrates separated by a plurality of barrier ribs;
wherein said vessel contains a dischargeable gas such that said field enhancing material is exposed to said dischargeable gas.

41. The plasma display of claim 40, wherein said field enhanced material is disposed between a first pixel and a second pixel.

42. The plasma display of claim 40, wherein said field enhanced material is disposed on a portion of said first substrate and aligned with at least one electrode on said second substrate.

43. The plasma display of claim 40, wherein a layer of phosphor material is deposited between at least a portion of said barrier ribs thereby producing phosphor layers such that said field enhancing material is inter-disposed with at least a portion of said phosphor material.

44. The plasma display according to claim 43, wherein said phosphor material is selected independently from the group consisting of: a red phosphor, a green phosphor, a blue phosphor and combination thereof.

45. The plasma display according to claim 44, wherein said phosphor layers are disposed between said barrier ribs.

46. The plasma display according to claim 40, wherein said field enhanced material is selected from the group consisting of: Carbon, Silicon, Silicon Oxide, Germanium, Germanium Oxide, Magnesium Oxide, Aluminum Oxide, Zinc, Zinc Oxide and a combination thereof.

47. The plasma display according to claim 40, wherein said field enhanced material is a nano material in the form of a nanotube, nanowire, nanobelt, nanotree, nanocone, nanofibres, nanocages, microtube, microwire, microcone, microfibers and a combination thereof.

48. The plasma display according to claim 47, wherein said nano material is Carbon.

49. The plasma display according to claim 40, wherein said field enhanced material is inter-disposed with at least a portion of the surface of said phosphor material.

50. The plasma display according to claim 43, wherein said field enhanced material is imbedded in said phosphor material.

51. The plasma display according to claim 43, wherein said field enhanced material is applied onto at least a portion of said phosphor layer.

52. The plasma display panel according to claim 43, further comprising field enhancement tips imbedded in said phosphor layers.

53. The plasma display according to claim 44, wherein said field enhanced material is applied to dissimilar portions of said red, green, and blue phosphor layers.

54. The plasma display panel according to claim 40, wherein at least a portion of said field enhanced nano material is an aligned array of field enhanced nano material.

55. The plasma display panel according to claim 40, further comprising, a binding material for binding said field enhanced material.

56. The plasma display panel according to claim 55, wherein said binding material is a phosphor material.

57. The plasma display panel according to claim 43, wherein said field enhanced material is deposited onto said phosphor layer by electrophoretic deposition.

58. The plasma display panel according to claim 43, wherein said field enhanced material is a nano material imbedded in said phosphor layer.

59. The plasma display panel according to claim 58, wherein said imbedded field enhanced nano material is formed by screen printing of field enhanced material on said barrier ribs of said back plate.

60. The plasma display panel according to claim 40, wherein said field enhanced material is formed by printing said field enhanced material on said barrier ribs of said back plate by an ink-jet process.

61. The plasma display panel according to claim 40, wherein said field enhanced material is formed by aerosol coating of said field enhanced material on a portion of said barrier ribs.

62. A plasma display panel, comprising:
a front plate having scan electrodes and sustain electrodes for each row of pixel sites;
a back plate having a plurality of column address electrodes disposed thereon;
a dielectric layer covering said column address electrodes;
a plurality of barrier ribs disposed above said dielectric layer separating said column address electrodes being in spaced adjacency therewith; and
a phosphor layer disposed on top of said dielectric layer between said barrier ribs;
wherein each of said phosphor layers comprises a field enhanced material that is disposed on the surface of each phosphor layer or is imbedded therein.

63. The plasma display panel according to claim 62, wherein each of said phosphor layer is selected independently from the group consisting of: a red phosphor, a green phosphor and a blue phosphor layer.

64. The plasma display panel according to claim 62, wherein said red phosphor, green phosphor and blue phosphor layers are sequentially disposed between said barrier ribs.

65. The plasma display panel according to claim 62, wherein said field enhanced material is selected from the group consisting of: Carbon, Silicon, Silicon Oxide, Germanium, Germanium Oxide, Magnesium Oxide, Aluminum Oxide, Zinc, Zinc Oxide and a combination thereof.

66. The plasma display panel according to claim 62, wherein said field enhanced material is a nano material in the form of a nanotube, nanowire, nanobelt, nanotree, nanocone, nanofibres, nanocages, microtube, microwire, microcone, microfibers and a combination thereof.

67. A plasma display panel, comprising:
a front plate having scan electrodes and sustain electrodes for each row of pixel sites;
a back plate having a plurality of column address electrodes disposed thereon;
a dielectric layer covering said column address electrodes;
a plurality of barrier ribs disposed above said dielectric layer separating said column address electrodes being in spaced adjacency therewith; and
a red phosphor layer, a green phosphor layer and blue phosphor layer sequentially disposed on top of said dielectric layer between said barrier ribs;
wherein each of said red, green and blue phosphor layers comprises a field enhanced material that is disposed on the surface of each phosphor layer or is imbedded therein.

68. The plasma display panel according to claim 67, wherein said field enhanced material is selected from the group consisting of: Carbon, Silicon, Silicon Oxide, Germanium, Germanium Oxide, Magnesium Oxide, Aluminum Oxide, Zinc, Zinc Oxide and a combination thereof.

69. The plasma display panel according to claim 67, wherein said field enhanced material a nano material in the form of a nanotube, nanowire, nanobelt, nanotree, nanocone, nanofibres, nanocages, microtube, microwire, microcone, microfibers and a combination thereof.

70. The plasma display panel according to claim 67, wherein said front plate is covered by a dielectric glass layer over said scan and said sustain electrodes.

71. The plasma display panel according to claim 67, wherein said dielectric glass layer is covered by a protective layer.

72. The plasma display panel according to claim 67, wherein said field enhanced material is applied onto at least a portion of each of said red, green and blue phosphor layers.

73. The plasma display panel according to claim 67, wherein said field enhanced material is imbedded in at least a portion of each of said red, green and blue phosphor layers.

74. The plasma display panel according to claim 67, wherein said field enhanced material is applied onto the entire surface of each of said red, green and blue phosphor layers.

75. The plasma display panel according to claim 67, wherein said field enhanced material is imbedded in the entire body of each of said red, green and blue phosphor layers.

76. The plasma display panel according to claim 67, wherein said field enhanced material is an aligned array of field enhanced nano material.

77. The plasma display panel according to claim 67, wherein at least a portion of said field enhanced nano material is an aligned array of field enhanced nano material.

78. The plasma display panel according to claim 67, further comprising:
a binding material for binding said field enhanced material.

79. The plasma display panel according to claim 78, wherein said binding material is a phosphor material.

80. The plasma display panel according to claim 67, further comprising field enhancement tips imbedded in said phosphor layers.

81. The plasma display panel according to claim 67, wherein said field enhanced material is deposited onto said phosphor layer by electrophoretic deposition.

82. The plasma display panel according to claim 67, wherein said field enhanced material is a nano material imbedded in said phosphor layers.

83. The plasma display panel according to claim 82, wherein said imbedded field enhanced nano material is formed by screen printing of said field enhanced material on said barrier ribs of said back plate.

84. The plasma display panel according to claim 67, wherein said field enhanced nano material is formed by printing of said field enhanced material on said barrier ribs of said back plate by an ink-jet process.

85. The plasma display panel according to claim 67, wherein said field enhanced material is formed by aerosol coating of said field enhanced material on said barrier ribs of said back plate.
